(19) United States
(12) Patent Application Publication
(10) Pub. No.: US 2024/0168722 A1
(43) Pub. Date: May 23, 2024

(54) APPARATUS AND METHOD FOR RANDOM VARIABLE GENERATION WITH INFINITE POSSIBLE OUTCOMES

(71) Applicant: AIRES A.T PRIVATE LIMITED, Singapore (SG)

(72) Inventor: Meng Liang LIM, Singapore (SG)

(73) Assignee: AIRES A.T PRIVATE LIMITED, Singapore (SG)

(21) Appl. No.: 18/226,684

(22) Filed: Jul. 26, 2023

(30) Foreign Application Priority Data
Nov. 18, 2022 (SG) 10202260138P

(51) Int. Cl. G06F 7/58

(52) U.S. Cl. CPC G06F 7/584

(57) ABSTRACT

Embodiments of the invention provide random number generators and methods that are able to generate numbers with infinite possible outcomes while being able to estimate efficiently the probability of random number generation failure due to hardware constraint(s).

### FIELD OF THE INVENTION

Embodiments of the invention relate to generation of random variable or number with infinite possible outcomes or range which may be utilised as symmetric key, random number, ciphertext, or in other entropy applications.

### BACKGROUND

Random number generators are known and may be used in statistical sampling, computer simulations and cryptography such as to generate random variables of symmetric keys.

Conventional random number generators are generally designed to choose or generate a random number from a finite range and with a uniform probability distribution.

On the other hand, a random number generator that is designed to choose or generate a random number from an infinite range presents two general problems: the first problem is the impossibility of having a uniform probability distribution for infinite possible outcomes; the second problem relates to physical hardware constraints, e.g., the generated number is too large to be stored in the available memory space.

### SUMMARY

According to a first aspect of the invention, a computer-implemented method comprising:
selecting or receiving a convergent infinite series;
based on the convergent infinite series, providing a Discrete probability distribution with infinite sample space having elements, including:
   selecting or receiving a first finite sample space, wherein the infinite space includes the first finite sample space and a second infinite sample space, and
   assigning an equal probability to first finite elements corresponding to the first finite sample space, and
   assigning probabilities, which are derived from the infinite terms of the convergent infinite series, to second infinite elements corresponding to the second infinite sample space, wherein the elements of the infinite sample space include the first finite elements and the second infinite elements;
ascertaining a cumulative probability distribution of the Discrete probability distribution;
estimating a probability of failure by ascertaining an integration approximation or improper integral of the convergent infinite series using a start limit based on an upper limit of a hardware data storage capacity per random variable and an end limit based on infinity; and
generating the at least one discrete random variable from the infinite sample space if the cumulative probability distribution is equivalent to one and if the probability of failure is less than a predetermined value.

Embodiments of the first aspect are provided as recited in claim 2 to claim 6.

According to a second aspect of the invention, a random number generation apparatus comprising:
at least one memory unit for storing computer-executable instructions; and
at least one computer processor communicably coupled to the at least memory unit and configured to: execute the computer-executable instructions to perform the method according to any one of claim 1 to claim 6.

According to a third aspect of the invention, a non-transitory, computer readable medium comprising computer-executable instructions configured to direct at least one computer processor to perform the method according to any one of claim 1 to claim 6.

### BRIEF DESCRIPTION OF DRAWINGS

Embodiments of the invention will be described in detail with reference to the accompanying drawings, in which:

FIG. 1A is a simplified flow chart showing a method for generating random number or variable according to an embodiment;

FIG. 1B is a simplified flow chart showing a method for generating random number or variable according to an embodiment; and

FIG. 10 is a simplified flow chart showing a method for generating random number or variable according to an embodiment.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. It is understood that the terminology used herein is for the purpose of describing particular embodiments only, and is not intended to limit the scope of the invention. In the drawings, like reference labels or numerals refer to same or similar functionalities or features throughout the several views. In the drawings, directional arrows shown between features illustrate data or information transfer therebetween in accordance with description of some embodiments but are not limited as such. In other words, data or information transfer in reverse to the directional arrows and/or not shown by directional arrow among features may be envisaged and are not shown to avoid obscuring description of the embodiments.

Embodiments described in the context of one of the apparatuses or methods are analogously valid for the other apparatuses or methods. Similarly, embodiments described in the context of an apparatus are analogously valid for a method, and vice versa.

Features that are described in the context of an embodiment or example may correspondingly be applicable to the same or similar features in the other embodiments or examples. Features that are described in the context of an embodiment or example may correspondingly be applicable to the other embodiments or examples, even if not explicitly described in these other embodiments or examples. Furthermore, additions and/or combinations and/or alternatives as described for a feature in the context of an embodiment or example may correspondingly be applicable to the same or similar feature in the other embodiments or examples.

It should be understood that the articles “a”, “an” and “the” as used with regard to a feature or element include a reference to one or more of the features or elements. The term “and/or” includes any and all combinations of one or more of the associated feature or element. The terms “comprising”, “including”, “having”, “involving” and any of their related terms, as used in description and claims, are intended to be open-ended and mean that there may be additional features or elements other than the listed ones. Identifiers such as “first”, “second”, “third”, and so on, are used merely as labels, and are not intended to impose numerical requirements on their objects, nor construed in a manner imposing any relative position or time sequence between limitations.

The term “coupled” and related terms are used in an operational sense and are not necessarily limited to a direct physical connection or coupling. Thus, for example, two devices may be coupled directly, or via one or more intermediary devices. Based on the present disclosure, a person of ordinary skill in the art will appreciate a variety of ways in which coupling exists in accordance with the aforementioned definition.

Mathematical notations used herein are generally well-known. For avoidance of doubt, example notations are described as follows. The notation \hat{ } is used to denote power of. For example, A\hat{ }b=A^{b}. For example, x\hat{ }2=(x)(x)=x². The notation ϵ is used to denote element of.

Mathematical concepts used herein are generally well-known. For avoidance of doubt, some concepts are described as follows. A “series” is the sum of the terms of a sequence of numbers. An “infinite series” is the sum of the terms of an infinite sequence of numbers or values which follow a rule. An infinite series is “convergent” if the sequence of its partial sums tends to a limit, i.e., when adding one after the other in the order given by the indices or index range, partial sums that become closer and closer to a constant number or value is obtained. A non-limiting example of convergent infinite series includes:

$${\sum }_{n = 1}^{∞} \frac{1}{{n}^{2}} = \frac{1}{1} + \frac{1}{4} + \frac{1}{9} + \frac{1}{16} + \frac{1}{25} + \frac{1}{36} + \frac{1}{49} + \frac{1}{64} … … … … … = \frac{{π}^{2}}{6}$$

Any series that is not convergent is said to be divergent. A non-limiting example of convergent infinite series includes:

$${\sum }_{n = 1}^{∞} \frac{1}{n} = \frac{1}{1} + \frac{1}{2} + \frac{1}{3} + \frac{1}{4} + \frac{1}{5} + \frac{1}{6} + \frac{1}{7} + \frac{1}{8} … … … … … {\sum }_{n = 1}^{∞} \frac{1}{n}$$

tends to infinity and diverges
A discrete probability distribution based on the above-identified convergent series have an index range of n=1 to n=infinity.

In the present disclosure, the phrase “sample space” is used to refer to the possible outcomes of choosing or generating a random number or variable. Depending on the possible outcomes, the “sample space” may refer to a countably infinite numerical index range (e.g., 1 to infinity as illustrated above) and/or a set of non-numerical elements (e.g., a, aa, aaa, aaaa, etc.). The term “elements” generally refers to the individual terms or outcomes in the sample space.

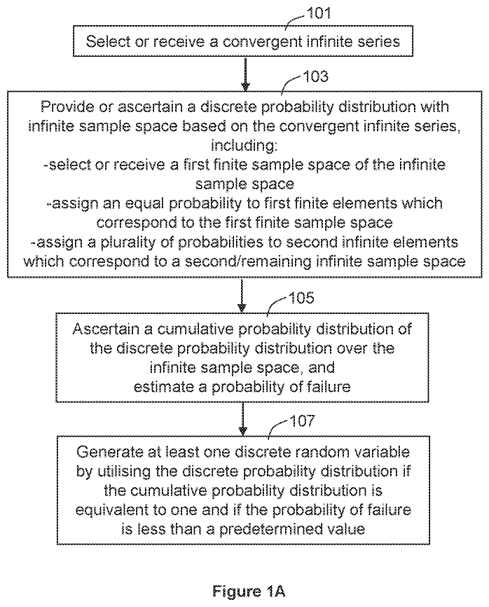

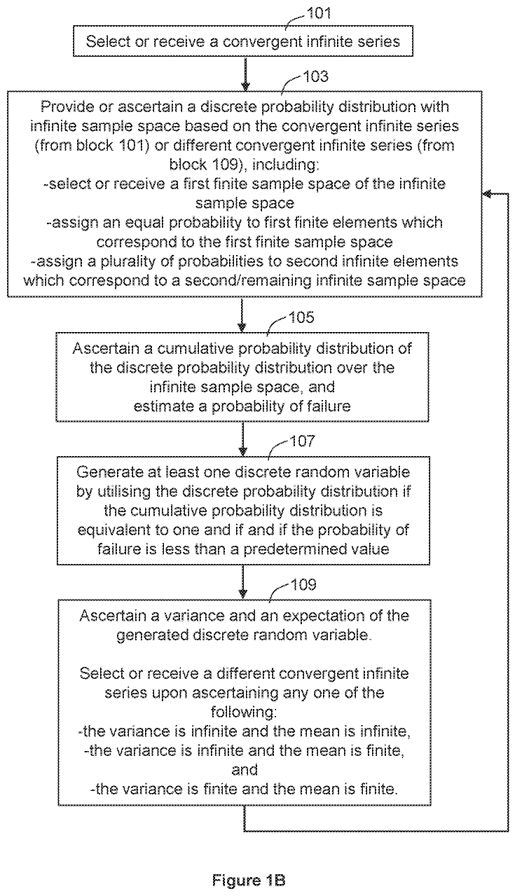

Reference is made to FIG. 1A which is a simplified flow chart showing a method for generating a random variable or number.

In block 101, a convergent infinite series is selected or received.

In block 103, based on the convergent infinite series, a discrete probability distribution with infinite sample space is provided or ascertained. This block includes one or more operations as follows.

A first finite sample space of the infinite sample space is selected or received. The first finite sample space may be arbitrarily or randomly selected, or pre-determined. Thus, a remaining space of the infinite sample space may include a second infinite sample space.

An equal or uniform probability is assigned to finite elements (hereinafter “first finite elements”) which correspond to the first finite sample space.

A plurality of probabilities are assigned to infinite elements (hereinafter “second infinite elements”) which correspond to the second infinite sample space. The plurality of assigned probabilities are derived from the infinite terms of the convergent infinite series and may be at least partially non-uniform. The first finite elements and the second infinite elements provide a plurality of elements of the infinite sample space.

In block 105, a cumulative probability distribution of the discrete probability distribution is ascertained, i.e., over the infinite sample space. Furthermore, a probability of failure may be estimated by ascertaining an integration approximation or improper integral of the convergent infinite series using a start limit based on an upper limit of a hardware data storage capacity per random variable and an end limit based on infinity.

In block 107, if the cumulative probability distribution, as ascertained in block 105, is equivalent to one, and if the probability of failure, as ascertained in block 105, is less than a predetermined value, at least one discrete random variable is generated by utilising the discrete probability distribution. The generated discrete random variable may be provided as a random number, a symmetric key, or a cipher text during generation of random number, symmetric key or cipher text, respectively.

Modifications may be made to the above-described method.

In an embodiment (see FIG. 1B), block 109 may be added in which a variance and an expectation of the generated discrete random variable may be ascertained. Furthermore, a different convergent infinite series may be selected or received upon ascertaining any one of the following:
a. the variance is infinite and the mean is infinite,
b. the variance is infinite and the mean is finite, and
c. the variance is finite and the mean is finite,

After a different convergent infinite series is selected or received, block 109 may proceed to block 103 such that blocks 103, 105 and 107 are performed based on the different convergent infinite series, as follows. In particular, in block 103, a different discrete probability distribution with the infinite sample space is provided based on the different convergent infinite series. A cumulative probability distribution of the different discrete probability distribution is ascertained, At least one different discrete random variable from the infinite sample space is generated if the cumulative probability distribution of the different Discrete probability distribution is equivalent to one.

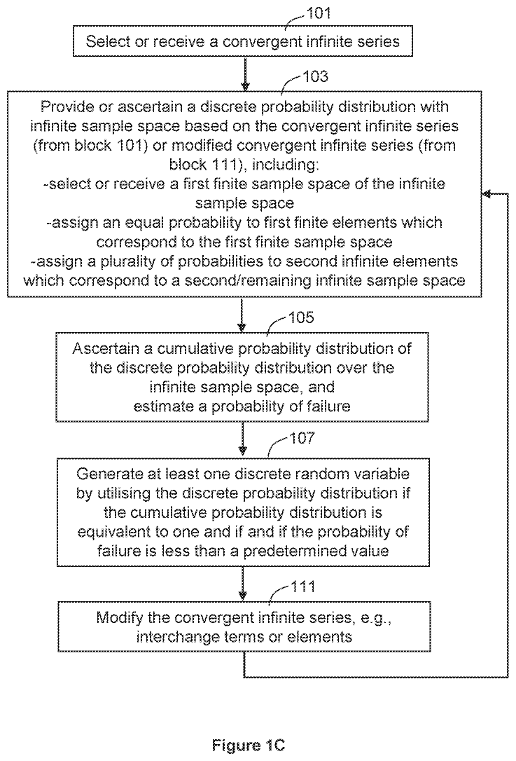

In an embodiment (see FIG. 10), block 111 may be added in which the discrete probability distribution with the infinite sample space is modified. After modifying the discrete probability distribution, block 111 may proceed to block 103 such that blocks 103, 105 and 107 are performed based on the modified discrete probability distribution, as follows. In particular, the equal probability of at least one of the first finite elements may be interchanged with at least one of the probabilities of at least one of the second infinite elements. A cumulative probability distribution of the modified discrete probability distribution may be ascertained. At least one discrete random variable may be generated by utilising the modified discrete probability distribution if the cumulative probability distribution is equivalent to one.

In other embodiment(s), at least some of the above-described modifications may be appropriately combined with or without further modifications. For example, the flowchart of FIG. 1A may additionally include block 109; or blocks 109 and 111.

The above-described embodiments may be utilised in generating symmetric key(s) in cryptography wherein embodiments of the invention may be used to generate and define variables with infinite range. This is contrasted with using a conventional random number generator for key generation where the generated variables will have a defined finite range.

For example, if a conventional random number generator with finite range from 1 to X and uniform probability distribution were used to produce a symmetric key, the symmetric key will have finite sample space or finite ramie. In contrast, if embodiments of the invention are used to produce a symmetric key , the symmetric key would have infinite sample space or infinite range.

### Method for Generating a Random Variable or Number

The above-described method for generating a random variable or number will be illustrated using an example, as follows:

Referring to block 101, the following convergent infinite series having infinite terms is selected or received:

$${\sum }_{n = 1}^{∞} \frac{1}{{n}^{2}} = \frac{1}{1} + \frac{1}{4} + \frac{1}{9} + \frac{1}{16} + \frac{1}{25} + \frac{1}{36} + \frac{1}{49} + \frac{1}{64} + …$$

The above convergent infinite series converges to

$$\frac{{π}^{2}}{6} .$$

Referring to block 103, based on the selected or received convergent infinite series, the probability distribution function of K, having infinite sample space, is provided or ascertained.

In this example, K denotes the random variable, c₁, c₂, c₃ϵ [symbol] , 2c_{f}<c₁<∞, −2c_{f}≤c₂≤2c_{f}, ∞<c₃<−2c_{f}

first finite sample space of the infinite sample space is selected or received by choosing a range 2c_{f}, either arbitrarily or as pre-determined.

An equal probability, i.e., uniform distribution, is assigned first finite elements, i.e., bounded variables, which correspond to the first finite sample space, i.e., −2c_{f}≤c₂≤2c_{f}. The equal probability may be arbitrary or pre-determined but has to be less than 1.

A plurality of probabilities, i.e., uniform and/or non-uniform probabilities, are assigned to second infinite elements, i.e., unbounded variables, which correspond to the second infinite sample space, i.e., 2c_{f}<c₁<∞, ∞<c₃<−2c_{f}.

Accordingly, probability distribution function of K may be represented by:

$$\{ \begin{matrix}2 {c}_{f} < K < ∞ & Pr ( K = {c}_{1} ) = \frac{1}{{c}_{1}^{2}} \\ - 2 {c}_{f} \leq K \leq 2 {c}_{f} & Pr ( K = {c}_{2} ) = \frac{1 - 2 ( \frac{{π}^{2}}{6} - 1 - {\sum }_{2}^{2 {c}_{f}} \frac{1}{{n}^{2}} )}{4 {c}_{f} + 1} \\ - ∞ < K < - 2 {c}_{f} & Pr ( K = {c}_{3} ) = \frac{1}{{c}_{3}^{2}}\end{matrix} \}$$

Referring to blocks 105 and 107, a cumulative probability distribution of the discrete probability distribution is ascertained, such as over the infinite sample space. In this example, based on the above convergent infinite series, the cumulative distribution function of −∞<K<∞ over the infinite sample space, i.e., 2c_{f}<c₁<∞, −2c_{f}≤c₂≤2c_{f}, ∞<c₃<−2c_{f} is exactly 1, as follows:

$${\sum }_{y = 2 {c}_{f} + 1}^{∞} Pr ( K = y ) = \frac{{π}^{2}}{6} - {\sum }_{n = 1}^{2 {c}_{f}} \frac{1}{{n}^{2}}$$

$${\sum }_{y = 2 {c}_{f} + 1}^{∞} Pr ( K = - y ) = \frac{{π}^{2}}{6} - {\sum }_{n = 1}^{2 {c}_{f}} \frac{1}{{n}^{2}}$$

$${\sum }_{y = - 2 {c}_{f}}^{∞} Pr ( K = y ) = 1 - 2 ( \frac{{π}^{2}}{6} - {\sum }_{n = 1}^{2 {c}_{f}} \frac{1}{{n}^{2}} )$$

### Note:

$${\sum }_{n = 1}^{∞} \frac{1}{{n}^{2}} = \frac{{π}^{2}}{6}$$

is known as the Basel problem and was first posed by Pietro Mengoli in 1650 and solved in 1734 by Leonhard Euler.

Further referring to block 107, based on the above that the cumulative probability distribution is equivalent to one, at least one discrete random variable, i.e. x₁, x₂, x₃, x₄, x₅, . . . is generated by utilising the discrete probability distribution of K over the infinite sample space.

The above method can be used for any symmetric key with countably infinite elements with cardinality equal to the set of integers or countably infinite elements with cardinality equal to the set of integers through mapping of probabilities.

Using the mid-point rule, an approximation (with infinite intervals of size 1) may be obtained using

$${\sum }_{n = 2 {c}_{f}}^{∞} \frac{1}{{n}^{2}} \approx {\int }_{2 {c}_{f} - 0.5}^{∞} \frac{1}{{x}^{2}} dx = \frac{1}{2 {c}_{f} - 0.5}$$

Upper and lower bounds of

$${\sum }_{n = 2 {c}_{f}}^{∞} \frac{1}{{n}^{2}}$$

may be ascertained using different integration formulas, approximations and techniques.
The above formula will be useful in calculating the probability of failure due to lack of memory space when generating the random variable.
For example, if there is an 8 digit data storage cap on the random variable, 2c_{f}=10⁹ may be chosen and

$${\sum }_{n = {10}^{9}}^{∞} \frac{1}{{n}^{2}}$$

represents the probability a random variable greater than 10⁹ or lesser than −10⁹ is generated.

In probability theory, the Central Limit Theorem establishes that, in many situations, when independent random variables are summed up, their properly normalized sum tends toward a normal distribution even if the original variables themselves are not normally distributed. However, the variance of the variable has to be finite. Hence, it may be preferred to create a probability distribution function with infinite variance to prevent the Central Limit Theorem from applying to the distribution K, as illustrated in the following example.

In an example where K is a discrete random variable, probability distribution function of K uses the reciprocals of powers of x²

$$\frac{{π}^{2}}{6} - 1 = \frac{1}{4} + \frac{1}{9} + \frac{1}{16} … … …$$

In this example, c₁, c₂, c₃ϵ [symbol] , 2c_{f}<c₁<∞, −2c_{f}≤c₂≤2c_{f}, ∞<c₃<−2c_{f}.
K has the following probability distribution:

$$\{ \begin{matrix}2 {c}_{f} < K < ∞ & Pr ( K = {c}_{1} ) = \frac{1}{{c}_{1}^{2}} \\ - 2 {c}_{f} \leq K \leq 2 {c}_{f} & Pr ( K = {c}_{2} ) = \frac{1 - 2 ( \frac{{π}^{2}}{6} - 1 - {\sum }_{2}^{2 {c}_{f}} \frac{1}{{n}^{2}} )}{4 {c}_{f} + 1} \\ - ∞ < K < - 2 {c}_{f} & Pr ( K = {c}_{3} ) = \frac{1}{{c}_{3}^{2}}\end{matrix} \}$$

A variance formula may be ascertained using

var(K)=Σ(k−μ)²Pr(K=k), kϵK.

Given that

$${\sum }_{n = 2 {c}_{f}}^{∞} \frac{1}{{n}^{2}} ( {n}^{2} ) = {\sum }_{n = 2 {c}_{f}}^{∞} 1 = ∞$$

the variance of K is infinite.

Note: the mean of the distribution μ is 0

Depending on the convergent infinite series chosen, it may be possible for the variance of K to be finite, for example if the reciprocals of powers of x⁴ is used instead of x² as the convergent infinite series, then the variance will be finite and the Central Limit Theorem maybe applied to a sampling of K.

The expectation of K may be ascertained using

ex(K)=Σ(k)Pr(K=k)

Given that

$${\sum }_{n = 2 {c}_{f}}^{∞} \frac{1}{{n}^{2}} ( n ) = {\sum }_{n = 2 {c}_{f}}^{∞} \frac{1}{n} = ∞$$

a one-sided probability distribution function of K with infinite expectation and infinite variance may be created.

In an example, referring to block 111, probabilities of specific outcomes of the discrete probability distribution with infinite space are rearranged. In other words, a convergent infinite series is modified to construct another convergent infinite series. Given that Σan is an absolutely convergent series, if bn is a rearrangement of an, then Σbn. is absolutely convergent and Σbn=Σan. An illustrative example is

$$\frac{1}{4} + \frac{1}{9} + {\sum }_{n = 4}^{∞} \frac{1}{{n}^{2}} = \frac{1}{9} + \frac{1}{4} + {\sum }_{n = 4}^{∞} \frac{1}{{n}^{2}}$$

The above is also known as the Riemann's Rearrangement Theorem.

Another example involves interchanging terms or elements with uniform distribution with terms or elements from the convergent infinite series.

Embodiments of the invention provide several advantages including but not limited to the following:

Embodiments of the invention can generate random variables with infinite variance and/or infinite mean while being able to estimate efficiently the probability of random number generation failure due to hardware constraints.

More generally, random number generators using the present disclosure are able to generate numbers with infinite possible outcomes while being able to estimate efficiently the probability of random number generation failure due to hardware constraint(s).

The use of integration formulas approximations and techniques will enable the efficient estimation of the probability of random number generation failure due to hardware constraints.

A symmetric key with infinite random outcomes may be constructed using the present disclosure. Such symmetric key which is based on random variables generated is more secure as the sample space of each random variable generated has infinite possible outcomes. On the other hand, a symmetric key which is based on random variables generated from conventional random number generators will have finite possible outcomes.

It is to be appreciated that the flow charts showing logic flows are representative of exemplary methodologies for performing novel aspects of the invention. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The flow charts showing logic flow may be implemented in software, firmware, hardware, or any combination thereof. In software and firmware embodiments, the logic flow may be implemented by computer executable instructions or code stored on a non-transitory computer readable medium or machine readable medium, such as an optical, magnetic or semiconductor storage. The computer-executable instructions are configured to direct at least one computer processor to perform the logic flow. The embodiments are not limited in this context.

It is to be appreciated that the apparatuses described herein are representative of exemplary apparatuses for performing novel aspects of the invention. Those skilled in the art will understand and appreciate that the apparatuses are not limited by their elements described herein. In any of the apparatuses described herein, it may comprise at least one memory unit and at least one processor communicably coupled thereto. The at least one processor may be any type of computer processor, such as a microprocessor, an embedded processor, a digital signal processor (DSP), a network processor, a multi-core processor, a single core processor, or other device configured to execute code or computer-executable instructions to perform or implement the flowcharts, algorithms, processes, or operations detailed herein. The at least one memory unit may be a non-transitory computer readable medium or machine readable medium for storing or comprising the code or computer-executable instructions. Examples include, but are not limited to, random access memory (RAM), read only memory (ROM), logic blocks of a field programmable gate array (FPGA), erasable programmable read only memory (EPROM), and electrically erasable programmable ROM (EEPROM). The processor may be additionally communicably coupled to an input device, e.g. keyboard, mouse, and/or a communication module, e.g. transceiver.

In an apparatus example, the processor may perform the operations described in relation to the flow charts of FIGS. 1A to IC. For example, in block 101, the processor may select (e.g., based on predetermined criteria and/or from predefined choices of convergent infinite series) or receive (e.g., from an input device, communication module or another processor) a convergent infinite series as required. In block 103, the processor may provide (e.g., from another processor) or ascertain the discrete probability distribution. The processor may arbitrarily or randomly select a first finite sample space (e.g., using predetermined criteria) or based on pre-determined values (e.g., received from an input device, communication module or another processor). The processor may assign equal or uniform probabilities to first finite elements and a plurality of probabilities to second infinite elements. In block 105, the processor may ascertain the cumulative probability distribution and a probability of failure. In block 107, the processor may verify the cumulative probability distribution against pre-determined criteria (e.g., whether the value is equivalent to one) and if the pre-determined criteria is satisfied, the processor may generate one or more random numbers and utilising the generated random numbers according to application. In block 109 (where applicable), the processor may ascertain a variance and an expectation of the generated discrete random variable and select or receive a different convergent infinite series if the ascertained variance and mean values comply with predetermined criteria. In block 111 (where applicable), the processor may ascertain or derive a modified discrete probability distribution.

It is to be understood that the embodiments and features described above should be considered exemplary and not restrictive. Many other embodiments will be apparent to those skilled in the art from consideration of the specification and practice of the invention. Furthermore, certain terminology has been used for the purposes of descriptive clarity, and not to limit the disclosed embodiments of the invention.

1-8. (canceled)

9. A computer-implemented method comprising:
selecting or receiving a convergent infinite series;
based on the convergent infinite series, providing a Discrete probability distribution with infinite sample space having elements, including:
selecting or receiving a first finite sample space, wherein the infinite space includes the first finite sample space and a second infinite sample space, and
assigning an equal probability to first finite elements corresponding to the first finite sample space, and
assigning probabilities, which are derived from the infinite terms of the convergent infinite series, to second infinite elements corresponding to the second infinite sample space, wherein the elements of the infinite sample space include the first finite elements and the second infinite elements;
ascertaining a cumulative probability distribution of the Discrete probability distribution;
estimating a probability of failure by ascertaining an integration approximation or improper integral of the convergent infinite series using a start limit based on an upper limit of a hardware data storage capacity per random variable and an end limit based on infinity; and
generating the at least one discrete random variable from the infinite sample space if the cumulative probability distribution is equivalent to one and if the probability of failure is less than a predetermined value.

10. The computer-implemented method of claim 9, wherein the infinite elements are non-numerical.

11. The computer-implemented method of claim 9, further comprising:
providing the at least one discrete random variable in producing a random number, constructing a symmetric key, or constructing a cipher text.

12. The computer-implemented method of claim 9, wherein the first finite sample space is arbitrarily selected.

13. The computer-implemented method of claim 9, further comprising:
ascertaining a variance and an expectation of discrete random variable;
selecting or receiving a different convergent infinite series upon ascertaining any one of the following:
the variance is infinite and the mean is infinite,
the variance is infinite and the mean is finite, and
the variance is finite and the mean is finite;
using the different convergent infinite series, providing a different Discrete probability distribution with the infinite sample space;
ascertaining a cumulative probability distribution of the different Discrete probability distribution; and
generating at least one different discrete random variable from the infinite sample space if the cumulative probability distribution of the different Discrete probability distribution is equivalent to one.

14. The computer-implemented method of claim 9, further comprising:
providing a modified Discrete probability distribution with the infinite sample space having the elements, including:
interchanging the equal probability of at least one of the first finite elements with at least one of the probabilities of at least one of the second infinite elements;
ascertaining a cumulative probability distribution of the modified Discrete probability distribution; and
generating at least one discrete random variable by utilizing the modified Discrete probability distribution if the cumulative probability distribution is equivalent to one.

15. A random number generation apparatus comprising:
at least one memory unit for storing computer-executable instructions; and
at least one computer processor communicably coupled to the at least memory unit and configured to: execute the computer-executable instructions to perform the method according to claim 9.

16. A non-transitory, computer readable medium comprising computer-executable instructions configured to direct at least one computer processor to perform the method according to claim 9.
